(19) United States
(12) Patent Application Publication
(10) Pub. No.: US 2018/0039337 A1
(43) Pub. Date: Feb. 8, 2018

(54) OPTICAL FILM AND USER INPUT SYSTEM

(71) Applicants: CHI HSIANG OPTICS CO., LTD., Zhubei City (TW); NEOLAB CONVERGENCE TAIWAN INC., Taipei City (TW)

(72) Inventors: Po-Hung YAO, Zhubei City (TW); Feng-Chih CHEN, Taipei City (TW); Hsien-Ching CHANG, Taipei City (TW)

(21) Appl. No.: 15/668,141

(22) Filed: Aug. 3, 2017

(30) Foreign Application Priority Data
Aug. 5, 2016 (TW) 105125011

(51) Int. Cl. G06F 3/03; G06F 3/038; G06F 3/042; G06F 3/0354

(52) U.S. Cl. CPC G06F 3/0317; G06F 3/0321; G06F 3/0354; G06F 3/0383; G06F 3/0421

(57) ABSTRACT

An optical film includes a substrate, a scattering layer, a coding pattern and a coating layer. The substrate has a sensing surface and an opposite back surface. The scattering layer is disposed on at least one of the sensing surface and the back surface of the substrate to scatter a sensing light. The coding pattern is disposed on the scattering layer to reflect the sensing light, wherein the coding pattern includes coded information. The coating layer covers the scattering layer and the coding pattern. The coding pattern of the optical film is able to diffusely reflect the sensing light, so that an optical reader device may obtain a uniform image of the coding pattern.

### BACKGROUND OF THE INVENTION

### 1. Field of the Invention

The present invention relates to an optical film and a user input system, particularly to an optical film and a user input system, which enables a user to use an optical reader device to input information.

### 2. Description of the Prior Art

There is a user input system, wherein a coding pattern containing addressing information is formed on a substrate, and the user uses an appropriate reader device to read the addressing information of the coding pattern, whereby the track of the reader device moving on the surface of the substrate is recorded. Generally, the reader device is in form of a pen-like structure, whereby the user can interact with an electronic device in a familiar writing way. In the field, how to acquire uniform and easy-to-recognize coding pattern is a very important subject for decoding the coding pattern.

### SUMMARY OF THE INVENTION

The present invention provides an optical film and a user input system, wherein a scattering layer is formed on an optical film, and wherein a reflective coding pattern with a diffuse reflection effect is formed on the scattering layer, whereby an optical reader device can acquire uniform and easy-to-recognize images of the coding pattern.

In one embodiment, the optical film of the present invention comprises a substrate, a scattering layer, a coding pattern, and a coating layer. The substrate has a sensing surface and a back surface opposite to the sensing surface. The scattering layer is disposed on at least one of the sensing surface and the back surface of the substrate to scatter a sensing light. The coding pattern is disposed on the scattering layer to reflect the sensing light. The coding pattern contains coded information. The coating layer covers the scattering layer and the coding pattern.

In another embodiment, the user input system of the present invention comprises an optical film and an optical reader device. The optical film further comprises a substrate, a scattering layer, a coding pattern and a coating layer. The substrate has a sensing surface and a back surface opposite to the sensing surface. The scattering layer is disposed on at least one of the sensing surface and the back surface of the substrate to scatter a sensing light. The coding pattern is disposed on the scattering layer to reflect the sensing light. The coding pattern contains coded information. The coating layer covers the scattering layer and the coding pattern. The optical reader device has a contact end, which is used to contact the sensing surface of the optical film. The optical reader device comprises a light-emitting unit, an image sensor, a processing unit, and a communication interface. The light-emitting unit emits a sensing light to illuminate the optical film. The image sensor detects the sensing light reflected by the coding pattern and outputs a sensed image. The processing unit is electrically connected with the image sensor and analyzes the sensed image to acquire coded information of the coding pattern. The communication interface is electrically connected with the processing unit and transmits the coded information to an external electronic device.

Below, embodiments are described in detail in cooperation with the attached drawings to make easily understood the objectives, technical contents, characteristics and accomplishments of the present invention.

### BRIEF DESCRIPTION OF THE DRAWINGS

FIG. 1 is a diagram schematically showing an optical film according to one embodiment of the present invention;

FIG. 2 is a top view schematically showing an optical film according to one embodiment of the present invention;

FIG. 3 is a top view schematically showing an optical film according to another embodiment of the present invention;

FIG. 4 is a diagram schematically showing a user input system according to one embodiment of the present invention;

FIG. 5 is a diagram schematically showing an optical reader device of a user input system according to one embodiment of the present invention;

FIG. 6 is a diagram schematically showing a configuration of a coding pattern according to one embodiment of the present invention; and

FIG. 7 is a diagram schematically showing a configuration of another coding pattern according to one embodiment of the present invention.

### DESCRIPTION OF THE PREFERRED EMBODIMENTS

The present invention will be described in detail with embodiments and attached drawings below. However, these embodiments are only to exemplify the present invention but not to limit the scope of the present invention. In addition to the embodiments described in the specification, the present invention also applies to other embodiments. Further, any modification, variation, or substitution, which can be easily made by the persons skilled in that art according to the embodiment of the present invention, is to be also included within the scope of the present invention, which is based on the claims stated below. Although many special details are provided herein to make the readers more fully understand the present invention, the present invention can still be practiced under a condition that these special details are partially or completely omitted. Besides, the elements or steps, which are well known by the persons skilled in the art, are not described herein lest the present invention be limited unnecessarily. Similar or identical elements are denoted with similar or identical symbols in the drawings. It should be noted: the drawings are only to depict the present invention schematically but not to show the real dimensions or quantities of the present invention. Besides, matterless details are not necessarily depicted in the drawings to achieve conciseness of the drawings.

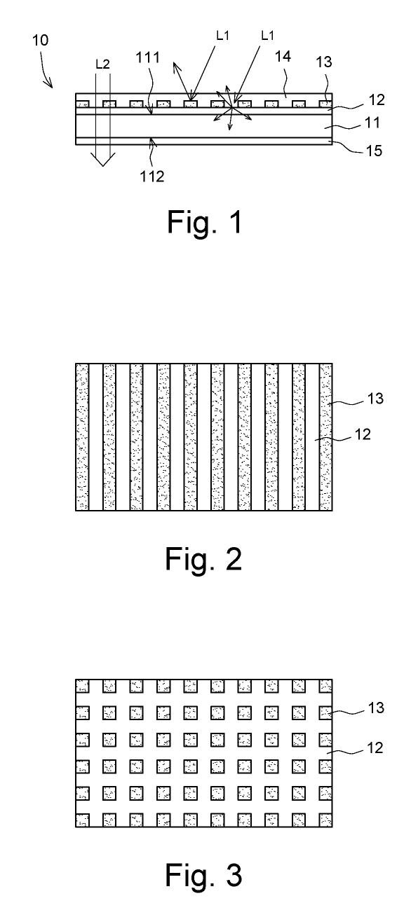

Refer to FIG. 1. In one embodiment, the optical film 10 of the present invention comprises a substrate 11, a scattering layer 12, a coding pattern 13, and a coating layer 14. The substrate 11 has a sensing surface 111 and a back surface 112 opposite to the sensing surface 111. In one embodiment, the substrate 11 is made of a material selected from a group including polyethylene terephthalate (PET), polycarbonate (PC), polymethylmethacrylate (PMMA), polyimide (PI), cellulose triacetate (TAC), cyclic olefin polymer (COP), and PC-PMMA composite films.

The scattering layer 12 is disposed on at least one of the sensing surface 111 and the back surface 112 of the substrate 11. In the embodiment shown in FIG. 1, the scattering layer 12 is disposed on the sensing surface 111. The scattering layer 12 can scatter a sensing light L1. In one embodiment, the sensing light L1 is an invisible light, such as an infrared light or an ultraviolet light. In one embodiment, the scattering layer 12 is the coarsened sensing surface 111 or back surface 112 of the substrate 11. It is easily understood: the scattering layer 12 is a continuous structure. Besides, the scattering layer 12 can also be realized via forming an additional unsmooth film on the sensing surface 111 or back surface 112 of the substrate 11 in other appropriate methods. unsmooth

The coding pattern 13 is disposed on the scattering layer 12. As the coding pattern 13 is reflective and disposed on the scattering layer 12, the coding pattern 13 can reflect the sensing light L1 diffusely. Thereby, the optical reader device can acquire a uniform and easy-to-recognize image of the coding pattern. In one embodiment, the coding pattern 13 includes a plurality of pattern units, and each pattern unit is selected from a group including a segment, an ellipse, a polygon, and combinations of segments, circles, ellipses and polygons. It is preferred: the lengths of the long axis and the short axis of each pattern unit are different. Thereby, the orientation of each pattern unit, such as the angle of rotation, can be determined. It is easily understood: the coding pattern 13 contains coded information, which may be at least one of addressing information, text information, graphic information, control instruction information, and anti-fake information.

In one embodiment, the coding pattern 13 is made of a metal, a metal oxide, or an alloy, which can provide reflectivity for the coding pattern 13. The metal may be selected from a group including gold, aluminum, silver, and copper. The metal oxide may be selected from a group including indium tin oxide (ITO), aluminum zinc oxide (AZO), and aluminum oxide. The alloy may be a nickel-copper alloy or a nickel-titanium-copper alloy. However, the present invention does not limit that the coding pattern must be made of the abovementioned materials. In one embodiment, the coding pattern 13 is formed via alternately stacking dielectric materials respectively having different refraction indexes. It is easily understood: the other technologies able to reflect the sensing light L1 can also be used to realize the coding pattern 13 of the present invention. In one embodiment, the thickness of the coding pattern 13 ranges from 3 nm to 20 μm. It is easily understood: the density, size, spacing and material of the coding pattern 13 can be appropriately modified to make the optical film of the present invention have a high transmittance (such as a transmittance of over 70%).

In one embodiment, the coding pattern 13 adopts a 1-dimensional structure (as shown in FIG. 2) or a 2-dimensional structure (as shown in FIG. 3) to reflect the sensing light L1 to a specified direction. If the distribution of the reflected light is not limited to a specified direction, the coding pattern 13 may be simply a coarsened structure.

The coating layer 14 covers the scattering layer 12 and the coding pattern 13. The coating layer 14 can prevent the coding pattern 13 from being abraded by frequent touch of the optical reader device. In one embodiment, the coating layer 14 has at least one of the following properties: hard coating, anti-glare, anti-reflection, anti-fingerprint, hydrophobicity, and anti-electrostatic. It is easily understood: the coating layer 14 may be a multilayer structure. In one embodiment, the refractivity of the coating structure 14 is identical to or different from that of the substrate 11. In one embodiment, the substrate 11, the scattering layer 12, the coding pattern 13 and the coating layer 14 allow a visible light L2 to pass, whereby the optical film 10 of the present invention can be applied to display devices. In other words, the visible lights presented by a display device can pass the optical film 10 of the present invention.

Refer to FIG. 1 again. In one embodiment, the optical film 10 of the present invention further comprises an adhesive layer 15, which is disposed on the back surface 112 of the substrate 11, whereby the optical film 10 of the present invention can be stuck to an appropriate operation surface, such as the surface of a display device or a whiteboard. In one embodiment, the adhesive layer 15 contains a light-absorption material able to absorb the light of specified wavelengths, such as a dye or another light absorbent. For example, a blue dye is added into the adhesive layer 15 to change the color tone of the optical film.

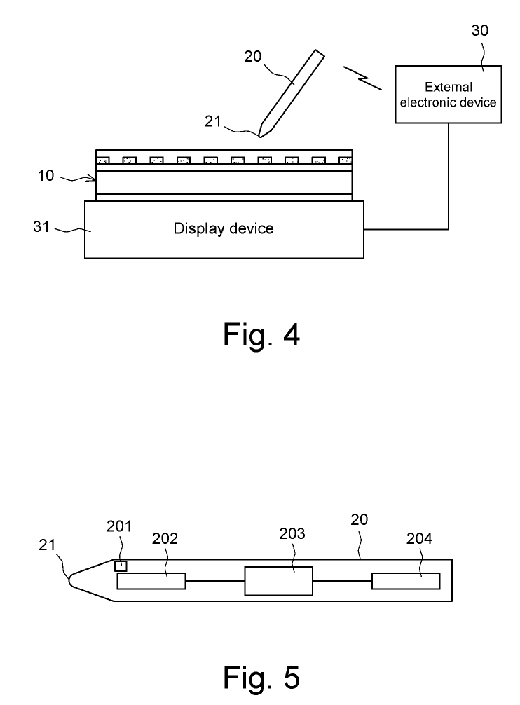

Refer to FIG. 4 and FIG. 5. In one embodiment, the user input system of the present invention comprises an optical film 10 and an optical reader device 20. The detailed structure of the optical film 10 has been described hereinbefore and will not repeat herein. The optical reader device 20 has a contact end 21 that the user uses to touch the sensing surface 111 of the optical film 10, whereby the user can interact with an electronic device in a familiar writing way. The optical reader device 20 comprises a light-emitting unit 201, an image sensor 202, a processing unit 203 and a communication interface 204.

The light-emitting unit 201 generates a sensing light L1 to illuminate the optical film 10. In one embodiment, the light-emitting unit 201 is an infrared or ultraviolet light-emitting diode (LED), preferably an infrared LED. The image sensor 202 detects the sensing light L1 reflected by the coding pattern and outputs a sensed image. In one embodiment, the image sensor 202 includes a charge coupled device (CCD) or a complementary metal oxide semiconductor (CMOS) sensor. In one embodiment, the lens of the image sensor 202 is made of poly methyl methacrylate (PMMA). The lens is usually fabricated in an injection molding method. PMMA features scratch resistance and has a light transmittance of about 90% for a light having a spectral peak of 810 nm. The CCD or CMOS device may have a size of 128×128 pixels. It is preferred: the CCD or CMOS device has a size of 140×140 pixels, which allows fabrication to have higher fault tolerance.

The processing unit 203 is electrically connected with the image sensor 202. The processing unit 203 can analyze the sensed image to acquire the coded information in the coding pattern, such as addressing information, text information, graphic information, control instruction information, or anti-fake information. The communication interface 204 is electrically connected with the processing unit 203. The communication interface 204 transmits the addressing information, text information, graphic information, control instruction information, or anti-fake information, which is acquired by the processing unit 203, to an external electronic device 30. In the present invention, the communication interface 204 is a wired communication interface or a wireless communication interface. It is preferred: the communication interface 204 is a wireless communication interface lest the cable interfere with the writing activity of the user. In one embodiment, the wireless communication interface is based on the Bluetooth technology, the wireless local area network (WLAN) technology, the ZigBee communication technology, the wireless USB technology, or the mobile communication network.

In one embodiment, the user input system of the present invention further comprises a display device 31, which is disposed on the back side of the optical film 10. In other words, the optical film 10 is disposed on the display surface of the display device 31. The display device 31 is electrically connected with the external electronic device 30. In such an architecture, the external electronic device 30 receives the coded information from the optical reader device 20, and the display device 31 presents the coded information. For an example, while the user sign or draw on the optical film 10, the external electronic device 30 can instantly present the signature or drawing of the user through the display device 31. For another example, while the user uses the optical reader device 20 to click on a special area of the optical film 10, the optical reader device 20 decodes the coding pattern in the special area to acquire the related control instruction, whereby the user can use the optical reader device 20 and the optical film 10 to undertake click-on, selection, page-down, scrolling, etc.

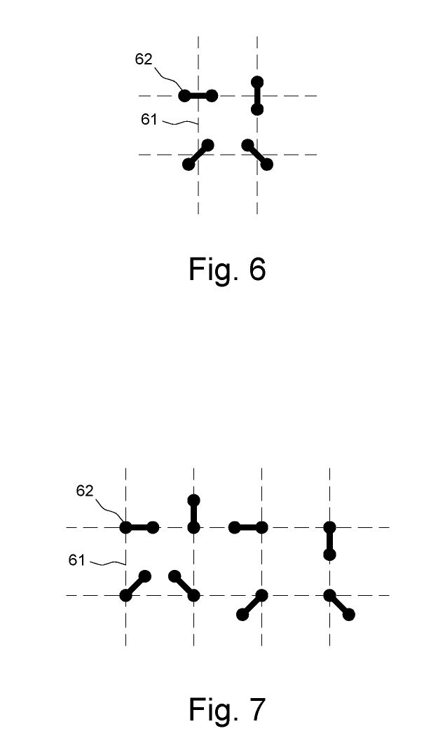

Refer to FIG. 6. In one embodiment, the coding pattern includes a virtual grid 61 and a plurality of pattern units 62. As the virtual grid 61 is not really drawn in the optical film 10, it is depicted with dashed lines. In the virtual grid 61, the dashed lines cross to form a plurality of intersection points. The coded information, such as addressing information, text information, graphic information, control instruction information, or anti-fake information, is coded according to the relative positions of the pattern units 62 to the intersection points of the virtual grid 61. In the embodiment shown in FIG. 6, the pattern unit 62 is formed by a segment and circles, and the center of the pattern unit 62 is located at the intersection point of the virtual grid 61. In FIG. 6, the pattern units 62, which are respectively horizontal, vertical, tilted left by 45 degrees and tilted right by 45 degrees, separately represent four code values. Thereby, the information can be coded with the pattern units 62. It is easily understood: sets formed by a plurality of pattern units 62 can be used to code more information.

Refer to FIG. 7. In one embodiment, the ends of pattern units 62 are located at the intersection points of the grid 61. In FIG. 7, the pattern units 62, which respectively rotate by 0, 45, 90, 135, 180, 270 and 315 degrees, separately represent eight code values. The coding method has been a technology well known by the persons with ordinary knowledge in the field. Further, the coding method is not the focus of the present invention. Therefore, it will not repeat herein. The present invention does not particularly limit that the information must be coded with a special method. In addition to the coding methods mentioned above, the information can also be coded in other appropriate methods.

In conclusion, the optical film and user input system of the present invention is characterized in that a scattering layer is disposed on the optical film and that a reflective coding pattern is disposed on the scattering layer. Thereby, the coding pattern has a diffuse reflection effect, and the optical reader device can acquire uniform and easy-to-recognize images of the coding pattern.

What is claimed is:

1. An optical film comprising
a substrate, having a sensing surface and a back surface opposite to the sensing surface;
a scattering layer, disposed on at least one of the sensing surface and the back surface of the substrate to scatter a sensing light;
a coding pattern, disposed on the scattering layer, reflecting the sensing light, and including coded information; and
a coating layer, covering the scattering layer and the coding pattern.

2. The optical film according to claim 1, wherein the substrate, the scattering layer, the coding pattern and the coating layer allow visible light to pass, and wherein the sensing light is an invisible light.

3. The optical film according to claim 1, wherein the scattering layer is formed via coarsening the sensing surface or back surface of the substrate.

4. The optical film according to claim 1, wherein the coding pattern is a 1-dimensional structure, a 2-dimensional structure, or a coarsened structure.

5. The optical film according to claim 1, wherein the coding pattern is made of a metal, a metal oxide, or an alloy.

6. The optical film according to claim 1, wherein the thickness of the coding pattern ranges from 3 nm to 20 μm.

7. The optical film according to claim 1, wherein the coding pattern is formed via alternately stacking dielectric materials respectively having different refraction indexes.

8. The optical film according to claim 1, wherein the coating layer has at least one of a hard coating property, an anti-glare property, an anti-reflection property, an anti-fingerprint property, a hydrophobic property, and an anti-electrostatic property.

9. The optical film according to claim 1 further comprising an adhesive layer disposed on the back surface of the substrate.

10. The optical film according to claim 9, wherein the adhesive layer includes a light-absorption material able absorb lights of specified wavelengths.

11. A user input system comprising
an optical film further comprising
a substrate, having a sensing surface and a back surface opposite to the sensing surface;
a scattering layer, disposed on at least one of the sensing surface and the back surface of the substrate to scatter a sensing light;
a coding pattern, disposed on the scattering layer, reflecting the sensing light, and including coded information; and
a coating layer, covering the scattering layer and the coding pattern; and
an optical reader device, having a contact end, which is used to contact the sensing surface of the optical film, and further comprising
a light-emitting unit, emitting the sensing light to illuminate the optical film;
an image sensor, detecting the sensing light reflected by the coding pattern and outputting a sensed image;
a processing unit, electrically connected with the image sensor and analyzing the sensed image to acquire the coded information of the coding pattern; and
a communication interface, electrically connected with the processing unit and transmitting the coded information to an external electronic device.

12. The user input system according to claim 11, wherein the substrate, the scattering layer, the coding pattern and the coating layer allow visible light to pass, and wherein the sensing light is an invisible light.

13. The user input system according to claim 11, wherein the scattering layer is formed via coarsening the sensing surface or back surface of the substrate.

14. The user input system according to claim 11, wherein the coding pattern is a 1-dimensional structure, a 2-dimensional structure, or a coarsened structure.

15. The user input system according to claim 11, wherein the coding pattern is made of a metal, a metal oxide, or an alloy.

16. The user input system according to claim 11, wherein the coding pattern is formed via alternately stacking dielectric materials respectively having different refraction indexes.

17. The user input system according to claim 11, wherein the coating layer has at least one of a hard coating property, an anti-glare property, an anti-reflection property, an anti-fingerprint property, a hydrophobic property, and an anti-electrostatic property.

18. The user input system according to claim 11, wherein the optical film further comprises an adhesive layer disposed on the back surface of the substrate.

19. The user input system according to claim 18, wherein the adhesive layer includes a light-absorption material able absorb lights of specified wavelengths.

20. The user input system according to claim 11 further comprising a display device disposed on a back side of the optical film and electrically connected with the external electronic device.
